(19) United States
(12) Patent Application Publication
(10) Pub. No.: US 2020/0201877 A1
(43) Pub. Date: Jun. 25, 2020

(54) GEOGRAPHIC LOCATION-BASED MULTIMEDIA INFORMATION DISPLAY

(71) Applicant: Alibaba Group Holding Limited, George Town (KY)

(72) Inventor: Xueqing Zou, Hangzhou (CN)

(73) Assignee: Alibaba Group Holding Limited, George Town (KY)

(21) Appl. No.: 16/804,732

(22) Filed: Feb. 28, 2020

Related U.S. Application Data
(63) Continuation of application No. PCT/CN2020/070889, filed on Jan. 8, 2020.

(30) Foreign Application Priority Data
Jun. 21, 2019 (CN) 201910542278.4

(51) Int. Cl. G06F 16/26; G06F 16/27; G06F 16/29; G06F 16/955; G06Q 50/14; H04W 4/029

(52) U.S. Cl. CPC G06F 16/26; G06F 16/27; G06F 16/29; G06Q 2220/00; G06Q 50/14; H04W 4/029; G06F 16/9554

(57) ABSTRACT

Implementations of this disclosure provide for geographic location-based multimedia information display. An example method performed by a node in a blockchain includes receiving transaction data generated by a client device, the transaction data including multimedia information and geographic location information, and in response to receiving the transaction data, performing consensus processing for a transaction, and publishing the transaction to the blockchain network, such that a terminal display device obtains the multimedia information from a blockchain network and displays the multimedia information. The blockchain node classifies transactions in the blockchain network based on the geographic location information to generate a plurality of transaction sets using the geographic location information as a category label, and provides the transaction sets to the terminal display device, such that the terminal display device displays multimedia information comprised in the transaction sets by category.

### CROSS-REFERENCE TO RELATED APPLICATIONS

This application is a continuation of PCT Application No. PCT/CN2020/070889, filed on Jan. 8, 2020, which claims priority to Chinese Patent Application No. 201910542278.4, filed on Jun. 21, 2019, and each application is hereby incorporated by reference in its entirety.

### TECHNICAL FIELD

Implementations of the present specification relate to the field of information technologies, and in particular, to geographic location-based methods, systems, and apparatuses, and devices.

### BACKGROUND

With the rapid development of blockchain technologies, its technical advantages such as de-centralization, security, and tamper prevention are widely concerned in various fields. Actual application of the blockchain technologies needs to be developed.

For example, in terms of tourism field, when a tourist travels in a scenic spot, the tourist usually takes photos for memory, and the tourist also consume in the scenic spot. However, in this respect, there is no visualized blockchain application that can be truly combined with a user demand currently.

### SUMMARY

Implementations of the present application aim to provide geographic location-based multimedia information display methods.

To alleviate the previous technical problem, the implementations of the present application are implemented as follows:

A geographic location-based multimedia information display method is provided and is applied to a blockchain system including a plurality of blockchain nodes, where the method includes: monitoring, by a client, an information acquisition instruction input by a user, to determine an information geographic location where the client is located when the client obtains information; determining, by the client, multimedia information generated corresponding to the information acquisition instruction, generating a transaction including the multimedia information and the information geographic location, and sending the transaction to the blockchain node; and performing, by the blockchain node, consensus processing on the transaction based on a consensus mechanism, and publishing the transaction to a blockchain network after consensus passes, so that a terminal display device displays the multimedia information stored in the blockchain.

Correspondingly, an implementation of the present specification further provides a geographic location-based multimedia information display system applied to a blockchain system including a plurality of blockchain nodes, where in the system, a client monitors an information acquisition instruction input by a user, to determine an information geographic location where the client is located when the client obtains information; determines multimedia information generated corresponding to the information acquisition instruction, generates a transaction including the multimedia information and the information geographic location, and sends the transaction to the blockchain node; and the blockchain node performs consensus processing on the transaction based on a consensus mechanism, and publishes the transaction to a blockchain network after consensus passes, so that a terminal display device displays the multimedia information stored in the blockchain.

According to another aspect, an implementation of the present specification further provides a geographic location-based multimedia information display method applied to a blockchain node in a blockchain system, where the method includes: receiving a transaction sent by a client, where the transaction includes multimedia information and an information geographic location; and performing consensus processing on the transaction based on a consensus mechanism, and publishing the transaction to a blockchain network after consensus passes, so that a terminal display device displays the multimedia information stored in the blockchain.

Corresponding to the another aspect, an implementation of the present specification further provides a geographic location-based multimedia information display apparatus applied to a blockchain node in a blockchain system, where the apparatus includes: a receiving module, configured to receive a transaction sent by a client, where the transaction includes multimedia information and an information geographic location; and a consensus module, configured to perform consensus processing on the transaction based on a consensus mechanism, and publishing the transaction to a blockchain network after consensus passes, so that a terminal display device displays the multimedia information stored in the blockchain.

In the implementations of the present specification, the client obtains the multimedia information, constructs the transaction including the information geographic location, and uploads the transaction to the blockchain node. The blockchain node performs consensus on the transaction and stores the transaction to the blockchain network, so as to classify existing stored transactions based on a geographic location, and display, on a terminal display device, the multimedia information related to a user based on the geographic location by category. Tourism information related to the user can be permanently stored through interaction between the client and the blockchain network, and can be displayed on a terminal device in a scenic spot. Moreover, the blockchain system can ensure authenticity and openness of the displayed multimedia information, thereby satisfying permanent recording and sharing of a good tourism memory of the user in the scenic spot, and facilitating mutual promotion between scenic spots.

It should be understood that the previous general description and the following detailed description are merely examples and explanations, and are not intended to limit the implementations of the present specification.

In addition, none of the implementations in the present specification implementation needs to achieve all the previously described effects.

### BRIEF DESCRIPTION OF DRAWINGS

To describe the technical solutions in the implementations of the present specification or in the existing technology more clearly, the following briefly describes the accompanying drawings needed for describing the implementations or the existing technology. Clearly, the accompanying drawings in the following description merely show some implementations of the present specification, and a person of ordinary skill in the art can still derive other drawings from these accompanying drawings.

FIG. 1 is a schematic diagram illustrating a system architecture, according to an implementation of the present specification;

FIG. 2 is a schematic flowchart illustrating a geographic location-based multimedia information display method, according to an implementation of the present specification;

FIG. 3 shows a geographic location-based multimedia information display method applied to a blockchain node, according to an implementation of the present specification;

FIG. 4 is a schematic structural diagram illustrating a geographic location-based multimedia information display apparatus, according to an implementation of the present specification; and

FIG. 5 is a schematic structural diagram illustrating a device used to configure the method in an implementation of the present specification.

### DESCRIPTION OF IMPLEMENTATIONS

To make a person skilled in the art better understand the technical solutions in the implementations of the present specification, the following describes in detail the technical solutions in the implementations of the present specification with reference to the accompanying drawings in the implementations of the present specification. Clearly, the described implementations are merely some but not all of the implementations of the present specification. All other implementations obtained by a person of ordinary skill in the art based on the implementations of the present specification shall fall within the protection scope of the present specification.

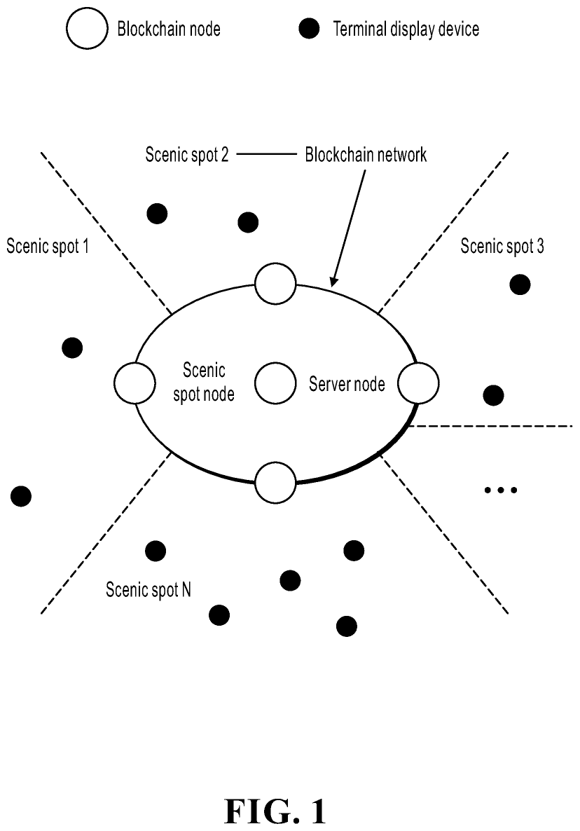

When a user currently travels in a scenic spot, a photo took by the user is usually stored in a local device of the user, and is not easily shared with another person. In addition, a terminal device in the scenic spot usually displays some advertisement promotion videos, and is not closely related to the user. Based on this, the implementations of the present specification provide a geographic location-based multimedia information display solution in a blockchain, and the solution is applied to a plurality of scenic spots. FIG. 1 is a schematic architectural diagram illustrating a blockchain system, according to an implementation of the present specification.

In the schematic diagram, a plurality of terminal display devices are dispersedly deployed in each scenic spot, and the terminal display device is connected to and communicates with a blockchain node. Generally, in this architecture, one corresponding blockchain node can be disposed in one scenic spot. In addition, a server corresponding to a client can be a blockchain node. The client (not shown in the figure) can communicate with the corresponding server.

Blockchains are usually classified into three types: a public blockchain, a private blockchain, and a consortium blockchain. In addition, there are several types of combinations, such as private blockchain+consortium blockchain, consortium blockchain+public blockchain, etc. The public blockchain has a highest de-centralization degree. The public blockchain is represented by Bitcoin and Ethereum. Participants who join the public blockchain can read data records on the blockchain, participate in transactions, and compete for accounting rights of new blocks. Moreover, each participant (namely, each node) can freely join and exit a network and perform a related operation. On the contrary, for the private blockchain, write permission of the network is controlled by an organization or an institution, and data read permission is specified by the organization. In short, the private blockchain can be a weak centralization system, and there is a small quantity of participating nodes and the nodes are strictly limited. This type of blockchain is more suitable for use within a specific mechanism. The consortium blockchain is a blockchain between the public blockchain and the private blockchain, and can be “partially decentralized”. Each node in the consortium blockchain usually has a corresponding entity institution or organization. Participants join the network through authorization and form interest-related consortiums, to jointly maintain blockchain operation.

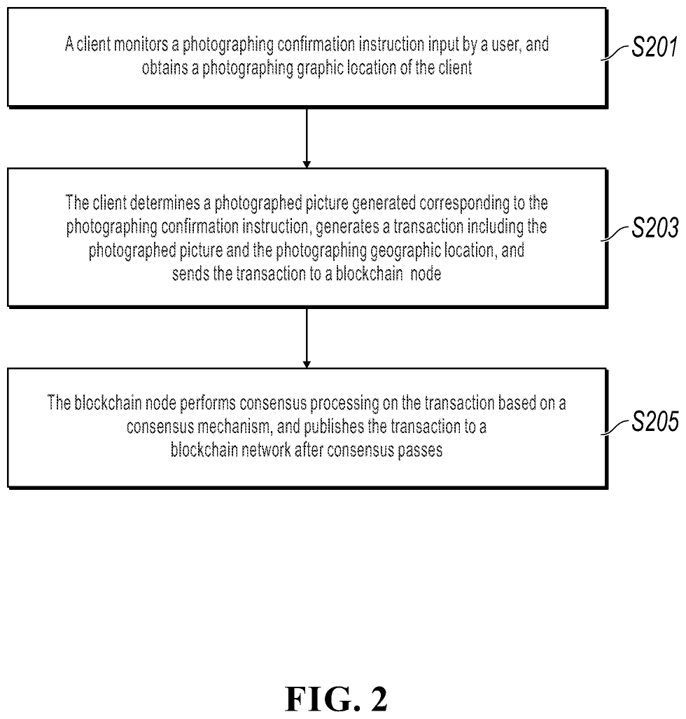

The technical solutions provided in the implementations of the present specification are described below in detail with reference to the accompanying drawings. FIG. 2 is a schematic flowchart illustrating a geographic location-based multimedia information display method, according to an implementation of the present specification. The method is applied to a blockchain system including a plurality of terminal display devices, and the procedure includes the following steps.

S201. A client monitors an information acquisition instruction input by a user, to determine an information geographic location where the client is located when the client obtains information.

The information acquisition instruction here can be a photographing instruction, a video recording instruction, a screenshot instruction, a document information input instruction, etc.

Photographing or video recording is used as an example. A user can take photos or record videos using an electronic device (for example, a mobile phone, a personal computer, or another device) that carries an electronic camera, or using a photographing device with an optical camera. It is worthwhile to note that the electronic device or the photographing device is usually a device having a positioning function and a communication function.

For example, when the user performs photographing by using the mobile phone, the user can send a photographing confirmation instruction by pressing a specified sensing module on the mobile phone. For another example, when the user performs photographing by using the photographing device with an optical camera, the user needs to perform photographing confirmation by pressing a shutter.

Each time the client detects the photographing confirmation instruction input to the client, the client can obtain a corresponding information geographic location through cooperation between a positioning module in a wireless terminal device and a wireless network. The information geographic location represents a photographing location of multimedia information.

The information geographic location here can be longitude and latitude coordinate data and height data, for example, a form of the geographic location is (longitude, latitude, height). Certainly, after the geographic location is obtained, the positioning module in the wireless terminal device can further determine a location name based on the information geographic location. Therefore, another form of the information geographic location can be “XXX tourism scenic spot”, etc. Because the information geographic location is obtained by being accompanied by the information acquisition instruction, the information geographic location represents a location of the user when the multimedia information is generated.

S203. The client determines multimedia information generated corresponding to the information acquisition instruction, generates a transaction including the multimedia information and the information geographic location, and sends the transaction to a blockchain node.

The multimedia information can be information such as a photo, a video, a screenshot, or document information that can be displayed. The multimedia information can further include personalized text information input by the user, for example, “xxx visits here”.

When user equipment where the client is located is a node in a blockchain network, the client can locally constructs a transaction by binding the information geographic location and the multimedia information after obtaining the information geographic location and the multimedia information. In this form, the blockchain network is in a form of a public blockchain.

If user equipment where the client is located is not a node in a blockchain, the client can send the obtained multimedia information and information geographic location to a node in the blockchain, so that the node constructs a transaction. In this form, the blockchain network is in a form of a consortium blockchain. In this case, only some predetermined nodes can perform consensus. For example, the nodes can be server devices and scenic spot node devices. In this implementation, it is unnecessary to construct a transaction on the local user equipment, which is more convenient and saves time of the user.

In the previous method for constructing a target transaction by using the server, transmission can be performed between the client and the server in a method similar to a Hyper Text Transfer Protocol over Secure Socket Layer (HTTPS), so as to ensure that information is not disclosed in a transmission process.

S205. The blockchain node performs consensus processing on the transaction based on a consensus mechanism, and publishes the transaction to a blockchain network after consensus passes, so that a terminal display device displays the multimedia information stored in the blockchain.

Multi-party storage of the transaction is implemented through consensus among the blockchain nodes. A photo taken by the user is permanently stored in the blockchain network, and cannot be tampered with. The terminal display device can obtain stored information from the blockchain network and display the information. Interaction between the client and the blockchain network ensures authenticity of the photo uploaded by the user.

In an implementation of the present specification, each blockchain node can be a full node, that is, the node has full data in the blockchain network. Therefore, any blockchain node can obtain a full transaction in the blockchain network. Further, the blockchain node classifies transactions by using the information geographic location included in the transactions as a category label.

A method in the classification process is as follows: Transactions with the same geographic location or similar geographic locations are classified into a same transaction set. In the previous method, several transaction sets corresponding to the same location can be obtained. For example, the obtained transaction sets can be a “Badaling set”, a “Jiuzhaigou set”, etc.

In this implementation, the terminal display device deployed in a scenic spot obtains the transaction sets including the category label, and displays multimedia information included in the transaction sets by category.

The terminal display device is deployed in each scenic spot, and is connected to a scenic spot blockchian node corresponding to the scenic spot. In other words, the terminal display device can obtain, from the scenic spot node, the transaction sets that have been classified, or the scenic spot node can push the transaction sets that have been classified to the terminal display device. Further, the terminal display device can obtain corresponding classified multimedia information from each transaction set. Certainly, in another implementation, the scenic spot blockchain node can obtain a classified multimedia information set from the transaction set in advance, and push the classified multimedia information set to the terminal display device.

The terminal display device can display the multimedia information by category. A method for display by category is as follows: The multimedia information of different categories is displayed in turn. In a process of displaying multimedia information of one category, the multimedia information of another category is not displayed. In a process of displaying multimedia information of the same category, a predetermined pieces of multimedia information can be displayed, for example, 10 pieces of multimedia information, or the multimedia information is displayed for predetermined duration, for example, 5 minutes.

In the process of displaying the multimedia information of the same category, a quantity of multimedia information may be too large to be completely displayed. In this case, multimedia information can be randomly selected for display; or a generation timestamp of the multimedia information of the same category is determined, and most recently generated multimedia information is selected from the multimedia information of the same category to be displayed.

Further, in the process of displaying the multimedia information of the same category, an information geographic location corresponding to the multimedia information can be further displayed. The geographic location here can be specific longitude and latitude data, a specific location name, or even a scenic spot name such as “Badaling”. In this implementation of the present specification, the client obtains the multimedia information, constructs the transaction including the information geographic location, and uploads the transaction to the blockchain node. The blockchain node performs consensus on the transaction and stores the transaction in the blockchain network, so as to classify existing stored transactions based on a geographic location, and display, on a terminal display device, the multimedia information photographed by a user based on the geographic location by category. Tourism information of the user can be permanently stored through interaction between the client and the blockchain network, and can be displayed on a terminal device in a scenic spot. Moreover, the blockchain system can ensure authenticity and openness of the displayed multimedia information, thereby satisfying permanent recording and sharing of a good tourism memory of the user in the scenic spot, and facilitating mutual promotion between scenic spots.

In an implementation, before the transaction is generated, the client can determine a user identifier (for example, a unique user name, user mailbox, user mobile number, etc.) corresponding to the transaction, and the client or the blockchain node generates a transaction including the multimedia information, the user identifier, and the information geographic location.

In this implementation, the blockchain node can further perform classification based on the user identifier included in the transaction. That is, the blockchain node determines a transaction sent by each user, generates a plurality of transaction sets using the user identifier as a category label. Each transaction set corresponds to one user identifier.

Further, the client can obtain a transaction set matching (the same as) the user identifier of the client from the blockchain node. The transaction set records historical information of the user in each scenic spot that is stored in the blockchain network. Therefore, the user can log in to a client of the user, query and display the historical information of the user by using the client, and further share the historical information with another user. In this method, historical tourism information of the user is permanently stored in the blockchain network, and the user can browse and share related tourism experience of the user at any time. In addition, the historical tourism information cannot be tampered with.

In an implementation, before the transaction is generated, a timestamp of a time when the user is taking a photo can be obtained by using user equipment. For example, when photographing by using a mobile phone, the user can obtain a current system time by using a time module on the mobile phone. Therefore, when the transaction is constructed, the previous generation timestamp is added, to further play a true sharing effect. Adding timestamp can prove that the user has reached a place at a specific time point, which is equivalent to that the user punches in the scenic spot.

Further, when displaying the multimedia information of the user, the client can sequentially display the multimedia information in a sequence of punching in times (that is, timestamps in the transaction), so as to display a historical footprint of the user in a past period of time, which is closer to actual experience of the user and improves user experience.

In an implementation, because of a relatively large quantity of scenic spots, there is a relatively large quantity of corresponding transaction sets with different category labels. To be closer to an actual scenario and the user, the terminal display device does not need to display all categories at this time.

The category label of the transaction set is the information geographic location of the multimedia information in the transaction. Therefore, a predetermined condition can be set based on a device geographic location where the terminal display device is located, to select a transaction set and display only multimedia information included in the selected transaction set. Specific predetermined selection conditions are enumerated below as examples:

In a first case, the information geographic location is the same as the device geographic location. That is, only multimedia information obtained through photographing in a local scenic spot is displayed. In this implementation, matching can be performed in any scenic spot by using a geographic location of the scenic spot, to obtain a transaction set generated by different users at the geographic location of the scenic spot, and further display multimedia information in the transaction set.

For example, a terminal display device in a scenic spot Huashan can obtain, from a blockchain node (for example, a Huashan scenic spot node or another node), a transaction set using a geographic location “Huashan” as a category identifier, and all transactions in the transaction set include the information geographic location “Huashan”. The transaction set represents tourism records generated by different users in the same scenic spot “Huashan”, and the terminal display device in the scenic spot Huashan can display multimedia information included in the transaction set.

In a second case, a distance between the information geographic location and the device geographic location does not exceed a predetermined distance. That is, multimedia information obtained through photographing in another scenic spot near the scenic spot can be displayed. The predetermined distance here can be set in the scenic spot. For example, the predetermined distance is 100 KM. A terminal device in a scenic spot “Summer Palace” can also display multimedia information related to a scenic spot “Imperial Palace”.

In a third case, the information geographic location and the device geographic location are different and have a predetermined mapping relationship. The predetermined mapping relationship here can be a mapping relationship between a plurality of geographic locations. In this case, commercial promotion can be performed between different scenic spots. For example, if four scenic spots A, B, C, and D reach an agreement to establish a mapping relationship between geographic locations of each other, in this implementation, a terminal display device in any one of A, B, C, and D can display multimedia information in a transaction generated in another scenic spot.

In practice, there can be more methods to select a transaction category based on a geographic location, and the methods are not enumerated one by one.

In an implementation, the blockchain node can further count a quantity of transactions in a category corresponding to each information geographic location, to determine a quantity of terminal display devices that should be deployed in a scenic spot corresponding to the information geographic location. It is easy to understand that the quantity of terminal display devices is positively correlated with the quantity of transactions.

In an implementation, the terminal display device can further display a two-dimensional code used to start a blockchain process. The two-dimensional code can further include a terminal display device identifier.

After the user scans the two-dimensional code, the user can start a blockchain process by using the client, and invoke a camera of the user, so that the user performs photographing. The blockchain process can implement the previous steps S201 and S203. In this method, operations of the user can be reduced, and product affinity between a product and the user can be improved.

Further, after scanning the two-dimensional code, the client can obtain the terminal display device identifier, and generates a transaction including the terminal display device identifier, the multimedia information, and the information geographic location.

Because a plurality of terminal display devices can exist in a scenic spot, a plurality of transactions can also exist at the same geographic location. In this implementation, the terminal display device can further divide a plurality of transactions included in the same category into sub categories, to obtain a transaction including a terminal display device identifier of the terminal display device, and displays multimedia information in the obtained transaction. In this method, the user can scan the code to invoke a corresponding process to perform photographing, immediately store in the blockchain as ledger data, and display the information before the user, so as to improve user experience.

In an implementation, a corresponding merchant exists in the scenic spot. To improve participation of the user, the user can also be encouraged to obtain a discount based on the multimedia information. Specifically, after the user sends and chains the transaction by using the client, the blockchain node determines a hash value of the transaction and returns the hash value to the client.

In this case, the user can display the corresponding hash value at the merchant in the scenic spot, for example, display the hash value to a scanning device of the merchant for identification, or directly establish communication with the merchant and send the hash value to the merchant. The merchant can obtain the corresponding transaction from the blockchain network through query based on the hash value, and obtains the geographic location included in the transaction.

When the merchant determines that the geographic location included in the transaction is consistent with a merchant geographic location (that is, all are a geographic location of the scenic spot), it can be determined that the user does chain the multimedia information in the scenic spot. In this case, the blockchain system can grant a corresponding preferential right to the client, for example, cash incentives, red packets, or redeemed points or coupons of the merchant.

If the transaction cannot be found, or the geographic location included in the found transaction is inconsistent with the merchant geographic location, it can be determined that the user has not photographed the multimedia information in the local scenic spot or stored the multimedia information in the blockchain network. The transaction is obtained by querying the hash, and consistency comparison is performed based on the geographic location in the transaction, so as to effectively prove whether the user chains related information in the scenic spot, and prevent user from making falsification. In one aspect, it ensures that the merchant is not cheated and suffers a loss; and in another aspect, participation of the user in information stored in the blockchain in the scenic spot can be improved, thereby facilitating publicity of the scenic spot.

Correspondingly, an implementation of the present specification further provides a geographic location-based multimedia information display system applied to a blockchain system including a plurality of blockchain nodes.

In the system, a client monitors an information acquisition instruction input by a user, to determine an information geographic location where the client is located when the client obtains information; determines multimedia information generated corresponding to the information acquisition instruction, generates a transaction including the multimedia information and the information geographic location, and sends the transaction to the blockchain node; and the blockchain node performs consensus processing on the transaction based on a consensus mechanism, and publishes the transaction to a blockchain network after consensus passes.

Further, the system includes a plurality of terminal display devices. The blockchain node classifies transactions in the blockchain network based on the information geographic location to generate a plurality of transaction sets using the information geographic location as a category label. The terminal display device obtains the transaction sets including the category label, and displays multimedia information included in the transaction sets by category.

Further, in the system, the client determines a generation timestamp of the multimedia information, and generates a transaction including the generation timestamp, the multimedia information, and the information geographic location.

Further, in the system, the terminal display device determines a device geographic location where each terminal display device is located, and obtains a transaction set whose category label corresponds to an information geographic location satisfying a predetermined condition with the device geographic location.

Further, in the system, the predetermined condition includes: the information geographic location is the same as the device geographic location, or a distance between the information geographic location and the device geographic location does not exceed a predetermined distance, or the information geographic location and the device geographic location are different and have a predetermined mapping relationship.

Further, in the system, the blockchain node counts a quantity of transactions in a category corresponding to each information geographic location, to determine a quantity of terminal display devices deployed at each information geographic location.

Further, in the system, the terminal display device displays a two-dimensional code used to start a blockchain photographing process, and the two-dimensional code includes a terminal display device identifier; correspondingly, the client scans the two-dimensional code to obtain the terminal display device identifier, and generates a transaction including the terminal display device identifier, the multimedia information, and the information geographic location; and correspondingly, the terminal display device obtains a transaction including the terminal display device identifier of the terminal display device from the different category labels, and displays the multimedia information included in the transaction including the terminal display device identifier of the terminal display device.

Further, in the system, the blockchain node determines a hash value of the received transaction, and returns the hash value to the client sending the transaction; the client sends the hash value to a merchant; and the merchant obtains the corresponding transaction from the blockchain network through query based on the hash value, and obtains the geographic location included in the transaction; and the merchant determines consistency between the geographic location and a merchant geographic location, so as to grant a preferential right to the client.

Further, in the system, the client determines a user identifier corresponding to the multimedia information, and generates a transaction including the multimedia information, the user identifier, and the information geographic location.

Further, in the system, the blockchain node classifies transactions in the blockchain network based on the user identifier to generate a plurality of transaction sets using the user identifier as a category label. Any client obtains a transaction set whose category label matches a user identifier of the client, and displays multimedia information and an information geographic location included in each transaction set.

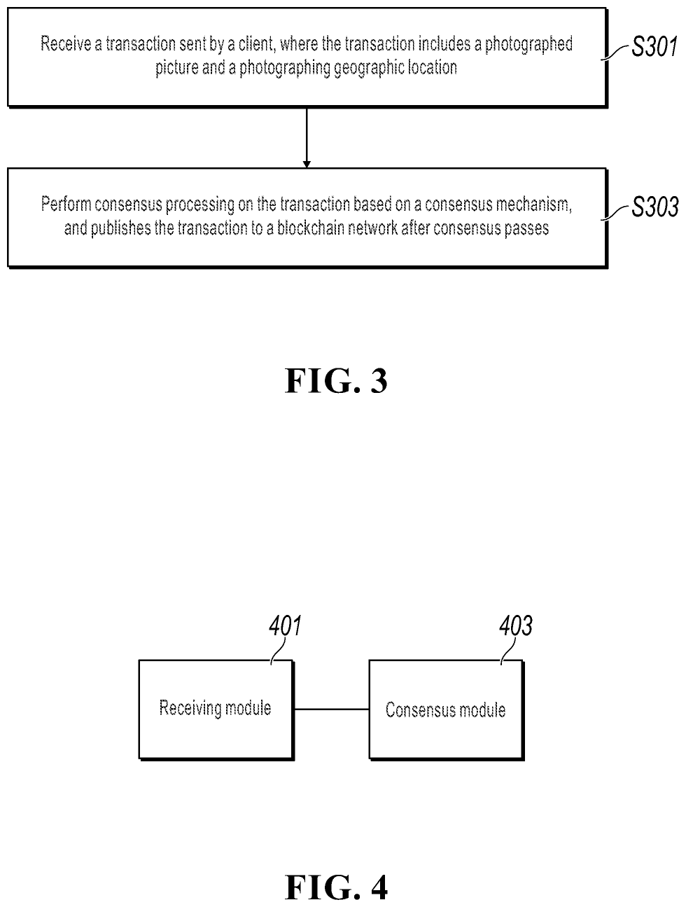

In another aspect, an implementation of the present specification further provides a geographic location-based multimedia information display method applied to a blockchain node in a blockchain system. FIG. 3 shows a geographic location-based multimedia information display method applied to a blockchain node, according to an implementation of the present specification, and the method includes the following steps:

S301. Receive a transaction sent by a client, where the transaction includes multimedia information and an information geographic location.

S303. Perform consensus processing on the transaction based on a consensus mechanism, and publish the transaction to a blockchain network after consensus passes, so that a terminal display device displays the multimedia information stored in the blockchain.

Further, the method includes: classifying transactions in the blockchain network based on the information geographic location to generate a plurality of transaction sets using the information geographic location as a category label.

Corresponding to the another aspect, an implementation of the present specification further provides a geographic location-based multimedia information display apparatus applied to a blockchain node in a blockchain system. FIG. 4 is a schematic structural diagram illustrating a geographic location-based multimedia information display apparatus, according to an implementation of the present specification, and the apparatus includes: a receiving module 401, configured to receive a transaction sent by a client, where the transaction includes multimedia information and an information geographic location; and a consensus module 403, configured to: perform consensus processing on the transaction based on a consensus mechanism, and publish the transaction to a blockchain network after consensus passes, so that a terminal display device displays the multimedia information stored in the blockchain.

Further, the apparatus includes a classification module 405, configured to classify transactions in the blockchain network based on the information geographic location, to generate a plurality of transaction sets using the information geographic location as a category label.

An implementation of the present specification further provides a computer device. The computer device includes at least a memory, a processor, and a computer program that is stored in the memory and that can run on the processor. When executing the program, the processor performs the multimedia information display method shown in FIG. 3.

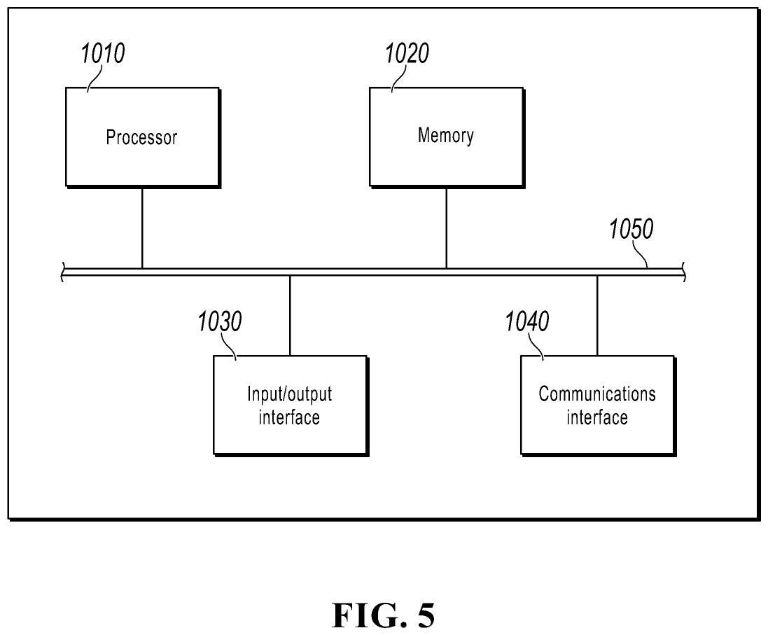

FIG. 5 is a schematic structural diagram illustrating a more specific hardware structure of a computing device, according to an implementation of the present specification. The device may include a processor 1010, a memory 1020, an input/output interface 1030, a communications interface 1040, and a bus 1050. A communication connection between the processor 1010, the memory 1020, the input/output interface 1030, and the communications interface 1040 is implemented inside the device by using the bus 1050.

The processor 1010 may be implemented by using a common central processing unit (CPU), a microprocessor, an application specific integrated circuit (ASIC), one or more integrated circuits, etc., and is configured to execute a related program, to implement the technical solutions provided in the implementations of the present specification.

The memory 1020 may be implemented in a form of a read-only memory (ROM), a random access memory (RAM), a static storage device, a dynamic storage device, etc. The memory 1020 may store an operating system and another application program. When the technical solutions provided in the implementations of the present specification are implemented by using software or firmware, related program code is stored in the memory 1020, and is invoked and executed by the processor 1010.

The input/output interface 1030 is configured to connect to the input/output module to input and output information. The input output/module (not shown in the figure) may be configured as a component in the device, or may be externally connected to the device to provide corresponding functions. The input device may include a keyboard, a mouse, a touchscreen, a microphone, various sensors, etc. The output device may include a display, a speaker, a vibrator, an indicator, etc.

The communications interface 1040 is configured to connect to a communications module (not shown in the figure), so as to implement communication and interaction between the device and another device. The communications module may implement communication in a wired method (for example, a USB or a network cable), or may implement communication in a wireless method (for example, a mobile network, WiFi, or Bluetooth).

The bus 1050 includes a channel for transmitting information between components (for example, the processor 1010, the memory 1020, the input/output interface 1030, and the communications interface 1040) of the device.

It is worthwhile to note that though the previous device shows only the processor 1010, the memory 1020, the input/output interface 1030, the communications interface 1040, and the bus 1050, in a specific implementation process, the device may further include another component required to implement normal operation. In addition, a person skilled in the art understands that the previous device may include only components required to implement the solutions in the implementations of the present specification, and does not need to include all the components shown in the figure.

An implementation of the present specification further provides a computer readable storage medium. The computer readable storage medium stores a computer program, and when a processor executes the program, the multimedia information method shown in FIG. 3 is implemented.

The computer readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc ready-only memory (CD-ROM), a digital versatile disc (DVD), or another optical storage, a cassette, a cassette magnetic disk storage, or another magnetic storage device or any other non-transmission medium. The computer storage medium can be configured to store information that can be accessed by a computing device. As described in the present specification, the computer readable medium does not include computer readable transitory media such as a modulated data signal and a carrier.

It can be seen from the previous descriptions of the implementations that, a person skilled in the art can clearly understand that the implementations of the present specification can be implemented by using software and a necessary general hardware platform. Based on such an understanding, the technical solutions in the implementations of the present specification essentially or the part contributing to the existing technology can be implemented in a form of a software product. The computer software product can be stored in a storage medium, such as a ROM/RAM, a magnetic disk, or an optical disc, and includes several instructions for instructing a computer device (which can be a personal computer, a server, a network device, etc.) to perform the method described in the implementations of the present specification or in some parts of the implementations of the present specification.

The system, method, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

The implementations in the present specification are described in a progressive way. For same or similar parts of the implementations, references can be made to the implementations mutually. Each implementation focuses on a difference from other implementations. Particularly, a device implementation is similar to a method implementation, and therefore is described briefly. For a related part, references can be made to some descriptions in the method implementation. The previously described method implementations are merely examples. The modules described as separate parts can or cannot be physically separate. During implementation of the solutions in the implementations of the present application, functions of the modules can be implemented in one or more pieces of software and/or hardware. Some or all of the modules can be selected based on an actual need to implement the solutions of the implementations. A person of ordinary skill in the art can understand and implement the implementations of the present specification without creative efforts.

The previous descriptions are merely specific implementations of the implementations of the present application. It is worthwhile to note that a person of ordinary skill in the art can further make several improvements or polishing without departing from the principle of the implementations of the present application, and the improvements or polishing shall fall within the protection scope of the implementations of the present application.

What is claimed is:

1. A computer-implemented method comprising:
receiving, by a blockchain node of a blockchain network and from a client device, transaction data generated by the client device, wherein the transaction data comprises multimedia information and geographic location information obtained by the client device, the geographic location information indicating a location of the client device at a time when the multimedia information was obtained by the client device; and
in response to receiving the transaction data
performing, by the blockchain node, consensus processing for a transaction based on a consensus mechanism,
publishing, by the blockchain node, the transaction to the blockchain network after consensus passes, such that a terminal display device obtains the multimedia information from the blockchain network and displays the multimedia information
classifying, by the blockchain node, transactions in the blockchain network based on the geographic location information to generate a plurality of transaction sets using the geographic location information as a category label, and
providing, by the blockchain network and to the terminal display device, the transaction sets comprising the category label, such that the terminal display device displays multimedia information comprised in the transaction sets by category.

2. The computer-implemented method of claim 1, wherein the transaction data generated by the client device further comprises a terminal display identifier based on a two-dimensional code displayed by the terminal display device and scanned by the client device to obtain the terminal display identifier and to start a blockchain process.

3. The computer-implemented method of claim 2, wherein providing, by the blockchain network and to the terminal display device, the transaction sets comprising the category label comprises:
determining a terminal device geographic location of the terminal display device; and
providing a first transaction set whose category label corresponds to geographic location information that satisfies a predetermined condition with respect to the terminal device geographic location.

4. The computer-implemented method of claim 3, wherein the predetermined condition comprises the geographic location information indicating a same location as the terminal device geographic location.

5. The computer-implemented method of claim 3, wherein the predetermined condition comprises a distance between a location indicated by the geographic location information and the terminal device geographic location not exceeding a predetermined distance.

6. The computer-implemented method of claim 3, wherein the predetermined condition specifies that a location indicated by the geographic location information is different from the terminal device geographic location and that the location indicated by the geographic location information and the terminal device geographic location have a predetermined mapping relationship.

7. The computer-implemented method of claim 1, further comprising:
counting, by the blockchain node, a quantity of transactions in a category corresponding to each location indicated by the geographic location information, to determine a quantity of terminal display devices deployed at each information geographic location.

8. The computer-implemented method of claim 1, further comprising:
determining, by the blockchain node, a hash value of the received transaction data, and returning the hash value to the client device from which the transaction data was received, wherein the client device sends the hash value to a merchant device; and
receiving, from the merchant device and by a node of the blockchain network, a query based on the hash value; and
in response to receiving the query based on the hash value, providing the geographic location information comprised in the transaction data, such that the merchant device, determines a consistency between a location indicated by the geographic location information and a merchant geographic location.

9. The computer-implemented method of claim 1, wherein the transaction data generated by the client device further comprises a user identifier corresponding to the multimedia information.

10. The computer-implemented method of claim 9, further comprising:
classifying, by the blockchain node, transactions in the blockchain network based on the user identifier to generate a plurality of transaction sets using the user identifier as a category label; and
providing, by the blockchain network and to the client device, a transaction set whose category identifier matches a user identifier of the client device, such that the client device displays multimedia information comprised in the transaction set.

11. A non-transitory, computer-readable medium storing one or more instructions executable by a computer system to perform operations comprising:
receiving, by a blockchain node of a blockchain network and from a client device, transaction data generated by the client device, wherein the transaction data comprises multimedia information and geographic location information obtained by the client device, the geographic location information indicating a location of the client device at a time when the multimedia information was obtained by the client device; and
in response to receiving the transaction data
performing, by the blockchain node, consensus processing for a transaction based on a consensus mechanism,
publishing, by the blockchain node, the transaction to the blockchain network after consensus passes, such that a terminal display device obtains the multimedia information from the blockchain network and displays the multimedia information
classifying, by the blockchain node, transactions in the blockchain network based on the geographic location information to generate a plurality of transaction sets using the geographic location information as a category label, and
providing, by the blockchain network and to the terminal display device, the transaction sets comprising the category label, such that the terminal display device displays multimedia information comprised in the transaction sets by category.

12. The computer-readable medium of claim 11, wherein the transaction data generated by the client device further comprises a terminal display identifier based on a two-dimensional code displayed by the terminal display device and scanned by the client device to obtain the terminal display identifier and to start a blockchain process, wherein providing, by the blockchain network and to the terminal display device, the transaction sets comprising the category label comprises:
determining a terminal device geographic location of the terminal display device; and
providing a first transaction set whose category label corresponds to geographic location information that satisfies a predetermined condition with respect to the terminal device geographic location.

13. The computer-readable medium of claim 11, the operations further comprising:
counting, by the blockchain node, a quantity of transactions in a category corresponding to each location indicated by the geographic location information, to determine a quantity of terminal display devices deployed at each information geographic location.

14. The computer-readable medium of claim 11, the operations further comprising:
determining, by the blockchain node, a hash value of the received transaction data, and returning the hash value to the client device from which the transaction data was received, wherein the client device sends the hash value to a merchant device; and
receiving, from the merchant device and by a node of the blockchain network, a query based on the hash value; and
in response to receiving the query based on the hash value, providing the geographic location information comprised in the transaction data, such that the merchant device, determines a consistency between a location indicated by the geographic location information and a merchant geographic location.

15. The computer-readable medium of claim 11, wherein the transaction data generated by the client device further comprises a user identifier corresponding to the multimedia information, the operations further comprising:
classifying, by the blockchain node, transactions in the blockchain network based on the user identifier to generate a plurality of transaction sets using the user identifier as a category label; and
providing, by the blockchain network and to the client device, a transaction set whose category identifier matches a user identifier of the client device, such that the client device displays multimedia information comprised in the transaction set.

16. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a blockchain node of a blockchain network and from a client device, transaction data generated by the client device, wherein the transaction data comprises multimedia information and geographic location information obtained by the client device, the geographic location information indicating a location of the client device at a time when the multimedia information was obtained by the client device; and
in response to receiving the transaction data
performing, by the blockchain node, consensus processing for a transaction based on a consensus mechanism,
publishing, by the blockchain node, the transaction to the blockchain network after consensus passes, such that a terminal display device obtains the multimedia information from the blockchain network and displays the multimedia information
classifying, by the blockchain node, transactions in the blockchain network based on the geographic location information to generate a plurality of transaction sets using the geographic location information as a category label, and
providing, by the blockchain network and to the terminal display device, the transaction sets comprising the category label, such that the terminal display device displays multimedia information comprised in the transaction sets by category.

17. The computer-implemented system of claim 16, wherein the transaction data generated by the client device further comprises a terminal display identifier based on a two-dimensional code displayed by the terminal display device and scanned by the client device to obtain the terminal display identifier and to start a blockchain process, wherein providing, by the blockchain network and to the terminal display device, the transaction sets comprising the category label comprises:
determining a terminal device geographic location of the terminal display device; and
providing a first transaction set whose category label corresponds to geographic location information that satisfies a predetermined condition with respect to the terminal device geographic location.

18. The computer-implemented system of claim 16, the operations further comprising:
counting, by the blockchain node, a quantity of transactions in a category corresponding to each location indicated by the geographic location information, to determine a quantity of terminal display devices deployed at each information geographic location.

19. The computer-implemented system of claim 16, the operations further comprising:
determining, by the blockchain node, a hash value of the received transaction data, and returning the hash value to the client device from which the transaction data was received, wherein the client device sends the hash value to a merchant device; and
receiving, from the merchant device and by a node of the blockchain network, a query based on the hash value; and
in response to receiving the query based on the hash value, providing the geographic location information comprised in the transaction data, such that the merchant device, determines a consistency between a location indicated by the geographic location information and a merchant geographic location.

20. The computer-implemented system of claim 16, wherein the transaction data generated by the client device further comprises a user identifier corresponding to the multimedia information, the operations further comprising:
classifying, by the blockchain node, transactions in the blockchain network based on the user identifier to generate a plurality of transaction sets using the user identifier as a category label; and
providing, by the blockchain network and to the client device, a transaction set whose category identifier matches a user identifier of the client device, such that the client device displays multimedia information comprised in the transaction set.
